(19) United States
(12) Patent Application Publication
(10) Pub. No.: US 2007/0158405 A1
(43) Pub. Date: Jul. 12, 2007

(54) Method and apparatus for managing content in a portable terminal

(75) Inventor: Dong-Gyo Lee, Seoul (KR)

Correspondence Address: DILWORTH & BARRESE, LLP, 333 EARLE OVINGTON BLVD., SUITE 702, UNIONDALE, NY, 11553, US

(73) Assignee: SAMSUNG ELECTRONICS CO., LTD., Suwon-si (KR)

(21) Appl. No.: 11/502,927

(22) Filed: Aug. 11, 2006

(30) Foreign Application Priority Data
Dec. 22, 2005 (KR) 2005-0127577

(51) Int. Cl. G06F 17/00

(52) U.S. Cl. 235/375

(57) ABSTRACT

Disclosed are a method and an apparatus for managing content using a labeling method in a portable terminal. The method for labeling content in the portable terminal includes selecting a label from a label database, selecting content from a content database and storing the content designated with the label in the content database.

### PRIORITY

This application claims priority under 35 U.S.C. § 119 to an application entitled “Method For Managing Content By Labeling In A Portable Terminal” filed in the Korean Intellectual Property Office on Dec. 22, 2005 and assigned Serial No. 2005-127577, the contents of which are incorporated herein by reference.

### BACKGROUND OF THE INVENTION

1. Field of the Invention

The present invention relates to a method and an apparatus for contents management in a portable terminal, and more particularly to an apparatus and a method for performing content management using labeling functions.

2. Description of the Related Art

Portable terminals such as mobile communication terminals, PDAs (Personal Digital Assistants), etc. are becoming commonplace. Portable terminals typically include functions for storing telephone numbers, taking pictures (e.g., using a built-in digital camera), editing documents, schedule management, editing moving pictures, playing games, performing telephone communications, etc.

Due to the multiple functions typical portable terminals provide, these portable terminals require complex menu trees to manage these functions. Accordingly, users must typically search menu trees to find a desired menu. For example, when storing data, users must manipulate the terminal and maneuver through a complex menu system in order to use a storing menu.

For example, if a user wants to search information on a friend's wedding in a portable terminal, the user must search menu trees to find one or more menus having desired content such as a wedding hall telephone number, a wedding schedule, a wedding hall location, documents related to the wedding, wedding photos, moving pictures, etc.

However, searching menu trees to find a respective menu to store or find information which has a common subject is inconvenient and wastes a user's time.

Accordingly, it is necessary to provide a method and an apparatus for managing content and for storing and searching content that can include a common subject.

### SUMMARY OF THE INVENTION

An object of the present invention is to provide a method for managing content having a common subject in a portable terminal.

Another object of the present invention is to provide an apparatus for managing content having a common subject in a portable terminal.

Also, another object of the present invention is to provide a method for managing content having a common subject using a method of labeling in a portable terminal.

Still, another object of the present invention is to provide an apparatus for managing content having a common subject using a method of labeling in a portable terminal.

According to the present invention for achieving the above and other objects, the method for labeling content in a portable terminal includes selecting a label, selecting content from a contents database and storing the content designated with the label in the content database.

According to the present invention for achieving the above and other objects, the method for searching content designated with a label in a portable terminal includes outputting a label list stored in a label database, selecting a label in the label list and searching a content group list included in the selected label from a content database.

According to the present invention for achieving the above and other objects, the method for deleting a label in a portable terminal includes selecting a label to be deleted after searching a label database, checking whether content designated with the label are also deleted and deleting only the label selected from the label database if the content is not to be deleted.

According to the present invention for achieving the above and other objects, the apparatus for labeling content includes a memory for storing a content database and a controller for selecting a label, selecting content from the content database, and storing the content designated with the label in the content database.

According to the present invention for achieving the above object, the apparatus for searching content designated with a label includes a memory for storing a label database and a content database, and a controller for outputting a label list stored in the label database, selecting a label in the label list, and searching a content group list included in the selected label from the content database.

According to the present invention for achieving the above and other objects, the apparatus for deleting a label includes a memory for storing a label database and a content database, and a controller for selecting a label to be deleted after searching the label database, checking whether content designated with the label is also deleted, and deleting only the label selected from the label database if the content is not to be deleted.

### BRIEF DESCRIPTION OF THE DRAWINGS

The above and other objects, features, and advantages of the present invention will become more apparent from the following detailed description when taken in conjunction with the accompanying drawings in which:

FIG. 1 is a block diagram illustrating a portable terminal for content management using labeling method according to the present invention;

FIG. 2 is a flow chart illustrating a method for storing content with a label registration in a portable terminal according to the present invention;

FIG. 3 is a flow chart illustrating another method for storing content with a label in a portable terminal according to the present invention;

FIG. 4 is a flow chart illustrating a method for searching labeled content in a portable terminal according to the present invention;

FIG. 5 illustrates various screen shots that are displayed on a display unit when labeled content is searched in a portable terminal according to the present invention; and

FIG. 6 is a flow chart illustrating a method for deleting a label in a portable terminal according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail.

The present invention relates to a method and an apparatus for content management using a labeling method in a portable terminal.

The content can include a telephone number, a short message, a multimedia message, a schedule, a memo, an image, a moving picture, and the like. The labeling method as used herein refers to a process of storing contents with their own labels.

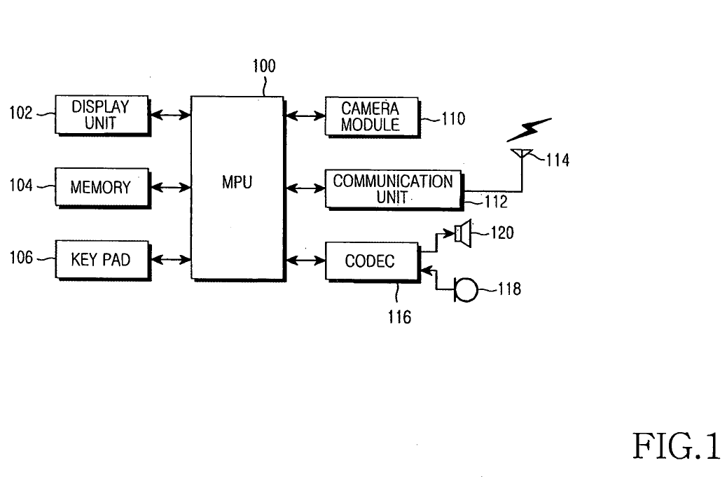

FIG. 1 is a block diagram of a portable terminal for content management using labeling according to the present invention. The portable terminal can include a cellular phone, a personal communication system terminal, a personal data assistant, or an International Mobile Telecommunication-2000 (IMT-2000) terminal. Hereinafter, configuration of the cellular phone will be described.

Referring to FIG. 1, the portable terminal can include a Micro-Processor Unit (MPU), acting as a controller 100, a display unit 102, a key pad 106, a memory (e.g., ROM, RAM, Flash Memory, etc.) 104, a camera module 110, a communication unit 112, an antenna 114, a Coder-Decoder (CODEC) 116, a microphone 118 and a speaker 120.

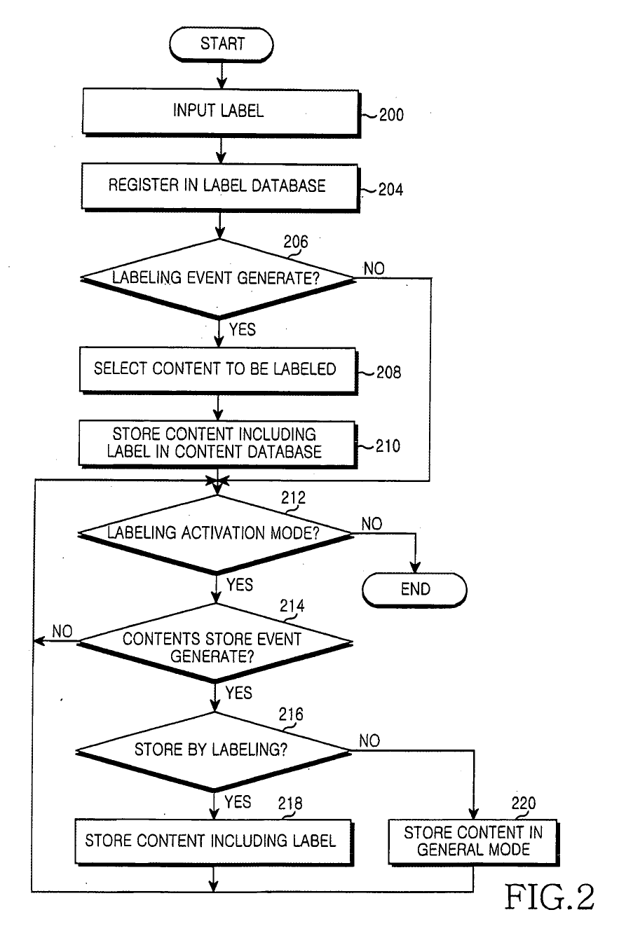

The Micro-Processor Unit (MPU) may be responsible for controlling an overall operation of the portable terminal. For example, the MPU 100 is responsible for processing and controlling voice communication and data communication. In addition to the typical functions, the MPU 100 performs a function for registration, searching, and deleting, of labels for managing content of the portable terminal. A detailed description of the function for registration, searching and deleting of labels will be described below with reference to FIGS. 2-6 for the sake of clarity, a description of the typical processing and controlling operation of the MPU 100 will not be described.

A display unit 102 displays status information generated during the operation of the mobile communication terminal, a restricted number of characters, moving pictures and/or still pictures. The display unit 102 may be a color Liquid Crystal Display (LCD) or other suitable display. The display unit may also include a touch-screen for receiving user inputs.

A key pad 106 includes numerical keys (e.g., 0-9) and a plurality of function keys, such as a MENU key, a CANCEL (REMOVE) key, an ENTER key, a TALK key, an END key, an Internet connection key, various navigation (directional) keys (e.g., ▴/▾/ [symbol] / [symbol] ). The key input data corresponding to a key pressed by the user is transmitted to the MPU 100. The key pad 106 may be part of the display unit 102 and/or may also include the microphone 118 for input of a voice command.

A Read Only Memory in memory 104 may store a program for controlling the overall operation of the portable terminal. A RAM in memory 104 may store temporary data being generated while performing all programs. Also, the flash memory in memory 104 may store a content database (e.g., that may include telephone numbers, short message service (SMS) messages and/or image data) for storing content and a label database for storing labels. The content database includes a field storing a label and the label database includes a label field and content information included in each label.

An optional camera module 110 includes an imaging device such as a charge coupled device (CCD) or a complementary metal oxide semiconductor (CMOS) chip for receiving an optical signal of a subject and converting the optical signal received through a lens into an electric signal.

A Coder-Decoder (CODEC) 112 is connected to the MPU 100. The microphone 118, and speaker 120 connected to the CODEC 112 form an audio input/output block for use in voice communication. The MPU 100 outputs Pulse Code Modulation (PCM) data and the CODEC 112 converts the PCM data into a corresponding analog audio signal. The analog audio signal is output through the speaker 120. Also, the CODEC 112 converts an analog audio signal received through the microphone 118 into corresponding PCM data and transmits the PCM data to the MPU 100.

A communication unit 112 performs despreading and channel decoding for reception data in case of the data reception. In case of the data transmission, the communication unit 112 performs channel coding and spreading of data, and can upconvert and transmit the data through the antenna 114. The communication unit 112 receives a base station identification number through a receiving pilot channel and can also down convert received signals.

A method of managing contents using labeling method in a portable terminal will now be described with reference to FIGS. 2-6.

FIG. 2 is a flow chart illustrating a method for storing content with a label in a portable terminal according to the present invention. A labeling activation mode is also explained.

The labeling activation mode is a mode in which new content is stored by automatically labeling a pre-selected label if a content storing event for storing the new content is generated. The content storing event for the new content is activated by a user's selection. For example, a user may select an event button or touch a corresponding menu item of an event touch screen to activate a content storing event.

Referring to FIG. 2, a label is input by a user manipulation in step 200. The input label is registered by storing in a label database in step 204. In step 206, it is determined whether a labeling event is generated. The labeling event is generated when content corresponding to the input label exists in content stored in a memory.

If the labeling event is not generated, the method proceeds to step 212 to determine whether to perform a labeling activation mode.

Referring back to step 206, if it is determined that the labeling event is generated, the method proceeds to step 208. In step 208 content to be labeled is selected. In step 210, the selected content designated with the label is stored in a content database and the method proceeds to step 212 to determine whether to perform a labeling activation mode.

In step 212, it is determined whether to perform the labeling activation mode. If it is determined not to perform the labeling activation mode, then the method ends.

In step 212, if it is determined to perform the labeling activation mode, the method proceeds to step 214 to determine whether a content storing event is generated. If it is determined that the content storing event is not generated, is the method proceeds to step 214 and determines whether a content storage event is generated.

In step 214 if it is determined that the content storing event is generated, the method proceeds to step 216 wherein it is determined whether the content will be stored using the label.

In step 216, if it is determined that the content will not be stored using the label, the method proceeds to step 220 and stores the content in the content database without a label.

However, in step 216, if it is determined that the content will be stored using the label, the method proceeds to step 218 and stores the content with the activated label in the content database.

Steps 216 and 220 are optional.

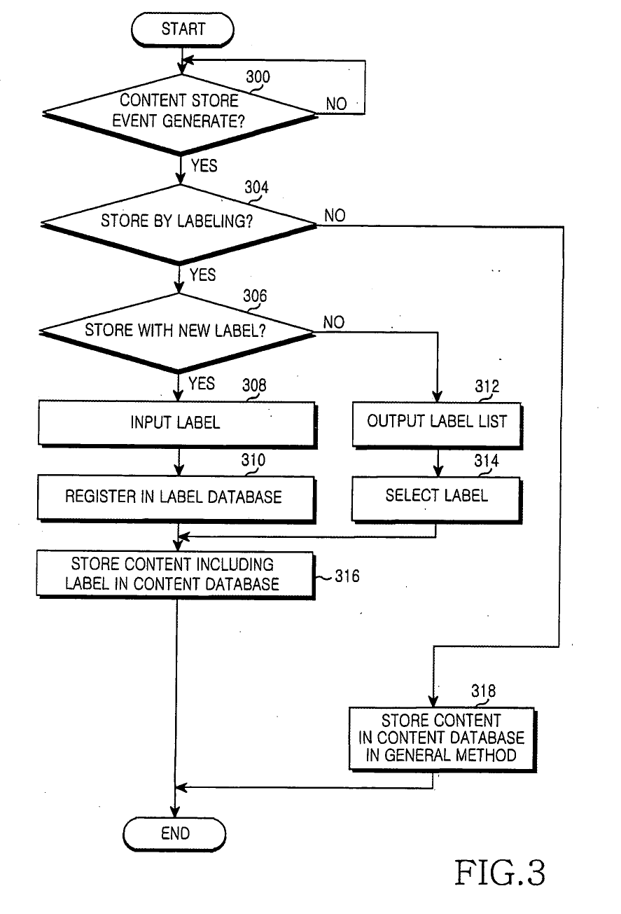

FIG. 3 is a flow chart illustrating storing content with a label in a portable terminal according to the present invention.

In step 300 it is determined whether a content storing event is generated. If it is determined that the content storing event is not generated, step 300 is repeated.

However, if it is determined that the content storing event is generated, the portable terminal proceeds to step 304 and determines whether the content will be stored with a label.

In step 304, it is determined that the content will not be stored with a label, the method proceeds to step 318 and stores the content without a label in the content database and the method ends.

However, in step 304 if it is determined that the content will be stored with a label, the method proceeds to step 306 wherein it is determined whether the contents will be stored with a new label.

In step 306 if it is determined that the content will be stored with a new label, a label is input by a user manipulation in step 308. The input label is then registered by storing it in a label database in step 310.

In step 316, the content including the input label is stored in the content database and the method ends.

Referring back to step 306, if it is determined that the content will not be stored with a new label, a label database is searched and a label list stored in the label database is output (for example, to the display for selection by the user) in step 312. A label to be included with the content is then selected in step 314 and the method continues to step 316.

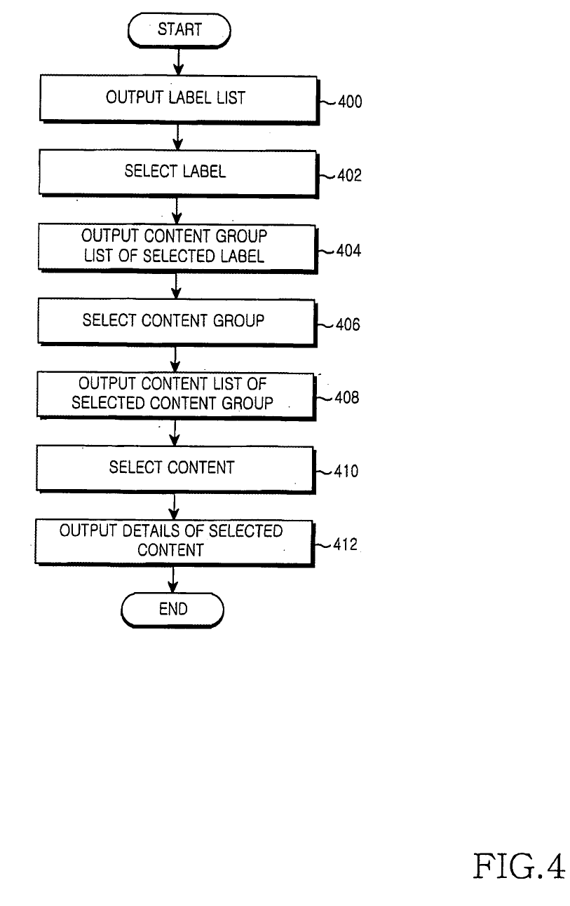

FIG. 4 is a flow chart illustrating a method for searching contents having a label in a portable terminal according to the present invention.

If the portable terminal receives a request of the label search (e.g., from a user), the portable terminal searches the label database and outputs (e.g., to the display) a label list in step 400. In step 402, if a label is selected (e.g., by the user) from the label list, the portable terminal outputs a content group list included in the selected label in step 404.

The content group list is a list including groups of content such as moving picture content, telephone number content or document content. The group includes respective common contents. In other words, the content group list can include a plurality of groups and the respective content of each group. For example, telephone number content would be stored in a common telephone number content group.

Next, a content group is selected from the content group list in step 406. After this, the list of content included in the selected content group is displayed or output in step 408.

In step 410, content is selected from the content list. The selected content is then output to a display unit 102 in step 412. If the selected content is a voice content, the selected content is output to a speaker 120.

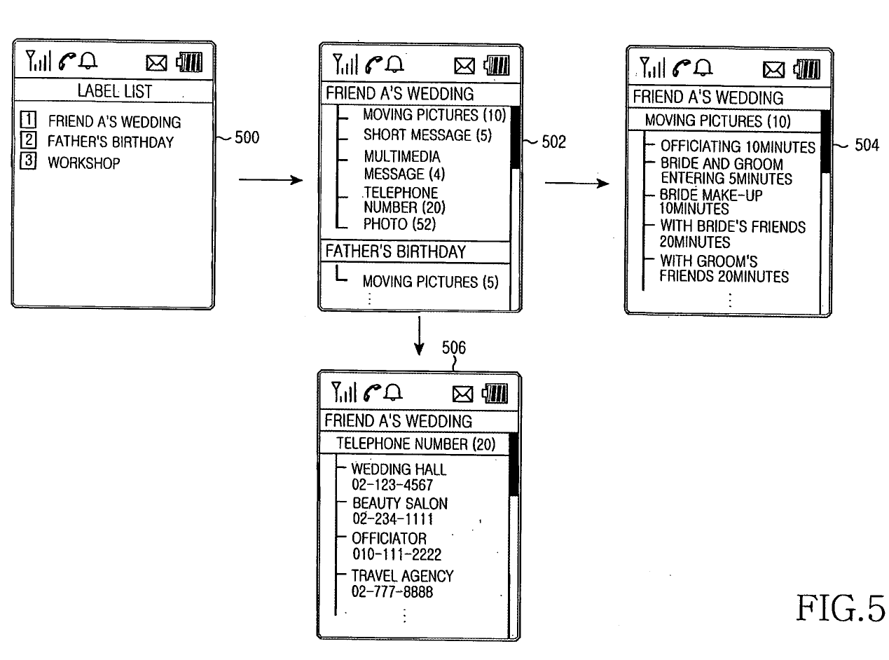

An embodiment of FIG. 4 will be described with reference to FIG. 5.

FIG. 5 illustrates screen shots on a display unit when labeled content is searched in a portable terminal according to the present invention.

A screen 500 shows a label list of ‘friend A's wedding’, ‘father's birthday’ and ‘workshop’ on a display unit.

A screen 502 shows a content group list included in the ‘friend A's wedding’ label and the number of content included in each group. A screen 504 shows a content list included in a moving picture contents group (as shown in screen 502) along with a running time when the moving picture content group (which is shown in screen 502) is selected (e.g., by the user). A screen 506 shows a telephone number list included in a telephone content group when the telephone content group (which is shown in screen 502) is selected.

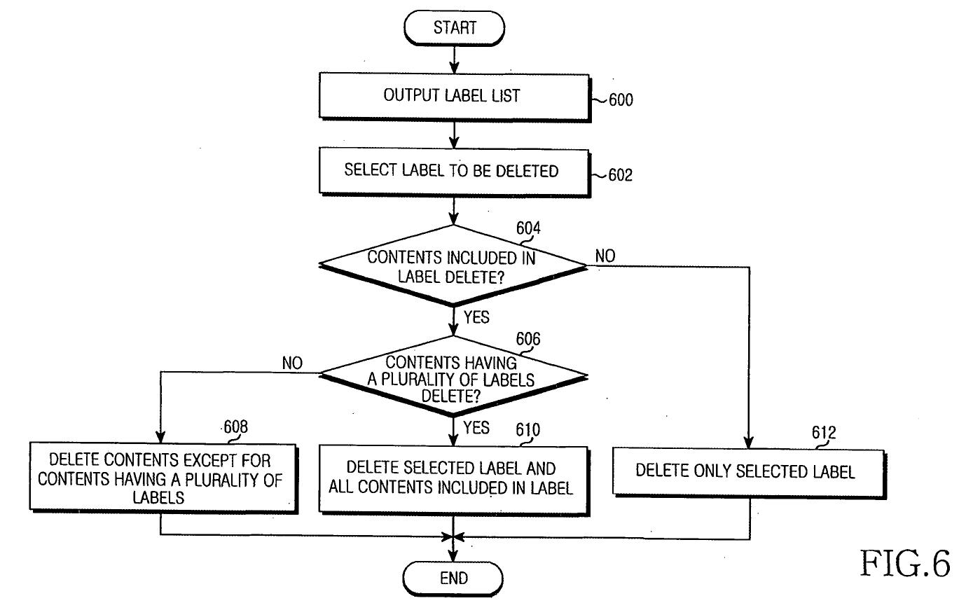

FIG. 6 is a flow chart illustrating a method for deleting a label in a portable terminal according to the present invention.

The portable terminal searches a label database and outputs a label list in step 600. In step 602, a label to be deleted from the label list is selected. It is determined whether content registered in the selected label is also to be deleted. If the content registered in the selected label is not to be deleted, only the selected label is deleted from the label database. In step 604, if it is determined that the content registered in the selected label is also to be deleted, the method proceeds to step 606. In step 606 it is determined whether content having a plurality of labels including a selected label is to be deleted. The plurality of labels means that the selected content has a plurality of labels. For example, a certain song may be saved with a plurality of labels such as a label indicating an author, a singer, a musical group/band, a class of music (e.g., rock, classical, etc.).

If it is determined the content having a plurality of labels is not to be deleted, only the selected label (and not the content) is deleted in step 608. Thus, if each stored content includes a plurality of labels, only the selected label is deleted.

However, if it is determined that the content having a plurality of labels is to be deleted (in step 606), the label selected from the label database is deleted and all corresponding content having the selected label stored in the content database is also deleted in step 610.

While the present invention has been shown and described with reference to certain preferred embodiments thereof, it will be understood by those skilled in the art that various changes in form and detail may be made therein without departing from the spirit and scope of the present invention as defined by the appended claims.

As described above, the present invention relates to a method and an apparatus for content management using labeling method in a portable terminal. In accordance with the present invention, a method and an apparatus for easy content management is provided.

What is claimed is:

1. A method for labeling contents in a portable terminal, comprising the steps of:
selecting a label;
selecting content from a content database; and
storing the content designated with the label in the content database.

2. The method of claim 1, wherein the step of selecting a label is performed after one of registering a new label and searching a label from a label database.

3. The method of claim 2, wherein step of registering the new label is performed by inputting a new label to be registered and storing the label in the label database.

4. The method of claim 1, wherein the step of selecting a label is performed by displaying a label list stored in the label database and selecting the label from the label list.

5. A method for searching content designated with a label in a portable terminal, comprising the steps of:
outputting a label list stored in a label database;
selecting a label included in the label list; and
searching a content group list included in the selected label from a content database.

6. The method of claim 5, further comprising:
selecting a content group from the content group list; and
outputting a content list included in the selected content group.

7. The method of claim 6, further comprising:
selecting content from the content list; and
outputting content included in the selected content.

8. A method for deleting a label in a portable terminal, comprising the steps of:
selecting a label to be deleted after searching a label database;
determining whether content designated by the label is also to be deleted; and
deleting only the label selected from the label database if it is determined that the content is not to be deleted.

9. The method of claim 8, further comprising:
deleting the label selected from the label database; and
deleting all content designated by the label if it is determined that the content is to be deleted.

10. The method of claim 9, wherein the step of determining whether content designated with the label is also to be deleted further includes determining whether the content designated by the label is designated by a plurality of labels.

11. A portable terminal for labeling content, comprising:
a memory for storing a content database; and
a controller for selecting a label, selecting content from the content database and storing the content designated by the label in the content database.

12. The portable terminal of claim 11, wherein the controller selects the label after one of registering a new label and searching a label from a label database.

13. The portable terminal of claim 12, wherein the controller registers the new label by receiving the new label to be registered and storing the new label in the label database.

14. The portable terminal of claim 11, wherein the label is selected by displaying a label list stored in a label database and selecting the label from the label list.

15. A portable terminal for searching content designated with a label, comprising:
a memory for storing a label database and a content database; and
a controller for outputting a label list stored in the label database, selecting a label in the label list and searching a content group list included in the selected label from the content database.

16. The portable terminal of claim 15, wherein the controller:
selects a content group from the content group list; and
outputs a content list included in the selected content group.

17. The portable terminal of claim 16, wherein the controller:
selects content from the content list; and
outputs content included in the selected content.

18. A portable terminal for deleting a label, comprising:
a memory for storing a label database and a content database; and
a controller for: selecting a label to be deleted after searching the label database;
determining whether content designated by the label is also to be deleted; and
deleting only the selected label from the label database if it is determined that the content is not to be deleted.

19. The portable terminal of claim 18, wherein the controller:
deletes the selected label selected from the label database and all content designated by the selected label if it is determined that the content is to be deleted.

20. The portable terminal of claim 19, wherein the controller determines whether content designated by the selected label is to be deleted by further determining whether content having a plurality of labels including the selected label is to be deleted.
